(19) United States
(12) Patent Application Publication
(10) Pub. No.: US 2009/0214459 A1
(43) Pub. Date: Aug. 27, 2009

(54) METHOD OF USING CERTAIN CATIONIC POLYMERS AS ANTIOXIDANTS OR FREE-RADICAL SCAVENGERS

(76) Inventors: Jean-Marc ASCIONE, Paris (FR); David W. Cannell, Plainfield, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/389,627

(22) Filed: Feb. 20, 2009

Related U.S. Application Data
(60) Provisional application No. 61/064,455, filed on Mar. 6, 2008.

(30) Foreign Application Priority Data
Feb. 22, 2008 (FR) 0851166

(51) Int. Cl. A61Q 5/00

(52) U.S. Cl. 424/70.11

(57) ABSTRACT

A method for providing a free-radical scavenging and/or antioxidant effect.

A cosmetic treatment composition contains at least one free-radical scavenger or at least one antioxidant chosen from at least one quaternary diammonium polycondensate comprising repeat units corresponding to the formula (I) below:

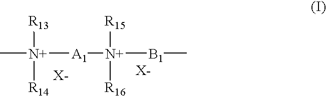

This application claims benefit of U.S. Provisional Application No. 61/064,455, filed Mar. 6, 2008, the contents of which are incorporated herein by reference. This application also claims benefit of priority under 35 U.S.C. § 119 to French Patent Application No. FR 0851166, filed Feb. 22, 2008, the contents of which are also incorporated herein by reference.

The present disclosure relates to the use of certain cationic polymers as antioxidants or free-radical scavengers, such as in a cosmetic composition such as a hair dye composition.

It is known to use antioxidants and/or free-radical scavengers in cosmetic compositions for combating the degradation of the compositions themselves or of the substrates on which they are applied. For example, it is known to use antioxidants or free-radical scavengers for reducing hair damage during application of hair compositions.

For example, Patent Application WO 2004/087086 describes a cosmetic composition comprising a free-radical scavenger compound having a diffusion constant less than or equal to 10⁻¹⁴ m²/s. Numerous free-radical scavenger compounds corresponding to this definition are cited.

Antioxidant or free-radical scavenger compounds used to date are products that are sometimes not very stable in cosmetic compositions or on the substrates to which they are applied. These products furthermore usually have little affinity for these substrates, especially for keratin substances such as the hair. They are then easily eliminated which reduces their ability to limit the degradation of the substrate. Their cosmetic impact is therefore usually mediocre or sometimes even unfavorable.

Finally, their effectiveness is often limited, such as in oxidizing compositions.

The present disclosure also relates to making available novel antioxidant or free-radical scavenging systems that may remedy at least one of the drawbacks of the prior art. For example, the disclosure relates to providing antioxidants or free-radical scavengers that may be one or all of very effective even in an oxidizing medium, easy to use in cosmetic compositions, stable, have a good affinity for the substrates to which they are applied such as the hair, and that have a good cosmetic effect.

Thus, one aspect of the present disclosure is a method for providing a free-radical scavenging and/or antioxidant effect comprising

including in a cosmetic treatment composition at least one free-radical scavenger or at least one antioxidant chosen from at least one quaternary diammonium polycondensate comprising repeat units corresponding to the formula (I) below as free-radical scavengers.

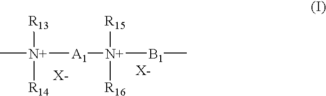

in which formula (I):

R₁₃, R₁₄, R₁₅ and R₁₆, which are identical or different, represent cyclic or non-cyclic aliphatic, or arylaliphatic groups comprising 1 to 6 carbon atoms or hydroxyalkylaliphatic groups comprising 1 to 4 carbon atoms, or else R₁₃, R₁₄, R₁₅ and R₁₆, together or separately, constitute, with the nitrogen atoms to which they are attached, heterocycles optionally comprising a second heteroatom other than nitrogen or else R₁₃, R₁₄, R₁₅ and R₁₆ represent a linear or branched C₁-C₆ alkyl radical substituted with a nitrile, ester, acyl, amide or —CO—O—R₁₇-D or —CO—NH—R₁₇-D group where R₁₇ is an alkylene group and D a quaternary ammonium group;

A₁ and B₁ represent polymethylene groups comprising 2 to 20 carbon atoms that may be linear or branched, saturated or unsaturated, and that may contain, linked to or inserted in the main chain, at least one aromatic ring, or at least one entity chosen from oxygen and sulphur atoms and sulphoxide, sulphone, disulphide, amino, alkylamino, hydroxyl, quaternary ammonium, ureido, amide and ester groups; and

X⁻ is a mineral or organic acid anion;

A₁, R₁₃ and R₁₅ may form, with the two nitrogen atoms to which they are attached, a piperazine ring.

This use makes it possible to obtain a lower deterioration of the substrates to which the polycondensate is applied, during or after the application. This improved respect for the integrity of the substrates is usually expressed by a better cosmetic appearance.

The substrates are, for example, keratin substances and such as keratin fibers, and further such as hair.

The method according to the disclosure relates, for example, to the use of the polycondensate of formula (I) in a hair dyeing composition comprising oxidation dyes.

According to at least one embodiment, the disclosure relates to the use of a quaternary ammonium polycondensate of formula (I) as free-radical scavenger and/or antioxidants in a hair dyeing composition comprising at least one oxidation dyes.

The polycondensate of formula (I) is generally applied in a cosmetic composition. Such a cosmetic composition comprises at least one quaternary diammonium polycondensates. These polycondensates are described above.

For example, in formula I, X⁻ is an anion such as chloride or bromide.

Exemplary polymers of this type are described in French Patent numbers 2,320,330, 2,270,846, 2,316,271, 2,336,434 and 2,413,907 and U.S. Pat. Nos. 2,273,780, 2,375,853, 2,388,614, 2,454,547, 3,206,462, 2,261,002, 2,271,378, 3,874,870, 4,001,432, 3,929,990, 3,966,904, 4,005,193, 4,025,617, 4,025,627, 4,025,653, 4,026,945 and 4,027,020.

Another aspect of the present disclosure is a method for providing a free-radical scavenging and/or antioxidant effect comprising

including in a cosmetic treatment composition at least one free-radical scavenger or at least one antioxidant chosen from at least one quaternary diammonium polycondensate composed of repeat units corresponding to the formula (a) below:

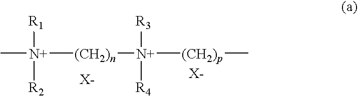

in which R₁, R₂, R₃ and R₄, which are identical or different, denote an alkyl or hydroxyalkyl group having from 1 to 4 carbon atoms, n and p are integers that vary from 2 to 6 and X⁻ is a mineral or organic acid anion.

In at least one embodiment, the compound of formula (a) is that for which R₁, R₂, R₃ and R₄ represent a methyl group and n=3, p=6 and X═Cl, that is to say the hexadimethrine chloride known as “Hexadimethrine chloride” according to the INCI (CTFA) nomenclature.

According to at least one embodiment, the polycondensate that may be used in the present disclosure has a cationic charge greater than 5 meq/g, such as greater than 6 meq/g. This charge density may be determined either by calculation from the structure of the polymer or experimentally via the Kjeldahl method.

According to at least one embodiment, the polycondensate can be used in an aqueous composition, such as a cosmetic hair composition comprising at least one oxidizing agent. Such hair compositions are generally used for dyeing or bleaching the hair.

As oxidizing agents that may be used, mention may be made of hydrogen peroxide, urea peroxide, alkali metal bromates, persalts such as perborates and persulphates, peracids and oxidase enzymes, among which non-limiting mention may be made of peroxidases, 2-electron oxidoreductases such as uricases and 4-electron oxygenases such as laccases and their possible cofactors such as uric acid for uricases. Further mention may be made of hydrogen peroxide.

The pH of the composition can range from 2 to 14, such as from 5 to 13.

Among the acidifying agents, mention may be made, by way of example, of mineral or organic acids such as hydrochloric acid, orthophosphoric acid, carboxylic acids such as tartaric acid, citric acid, lactic acid, or sulphonic acids.

According to one variant, the cosmetic composition has an alkaline pH ranging from 7 to 14, such as from 8 to 12. As alkaline agents that may be present, non-limiting mention may be made of ammonium hydroxide, alkali metal carbonates, ammonium carbonate, amino acids and, for example, basic amino acids such as lysine or arginine, alkanolamines such as mono-, di- and triethanolamines and derivatives thereof, sodium or potassium hydroxides and compounds of the following formula:

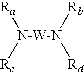

in which W is a propylene residue optionally substituted with a hydroxyl group or a C₁-C₄ alkyl radical; Ra, Rb, Rc and Rd, which are identical or different, represent a hydrogen atom, a C₁-C₄ alkyl radical or C₁-C₄ hydroxyalkyl radical.

The at least one polycondensate can be present in the cosmetic composition in an amount ranging from 0.00001% to 10% by weight relative to the weight of the composition.

The amount of water present in the cosmetic composition is in general from 5 to 95%, such as from 20 to 90%, further such as from 30 to 80%.

The composition may be present in various forms, such as in the form of liquids, creams, gels, or in any other form suitable for being applied to keratin fibers, such as human hair. The cosmetic composition comprising the at least one polycondensate may be a cosmetic composition for treating the hair or a dyeing composition.

The method of the present disclosure can make it possible to effectively combat the destructive effect of free radicals such as hydroxyl radicals OH°. This action on the hydroxyl radicals can be beneficial in the oxidizing media used in oxidation dyeing of the hair since these radicals are often responsible for the degradation of the keratin fibers. This use makes it possible, such as, to improve the free-radical scavenging and/or antioxidant effect, when the dyeing composition is mixed with the oxidizing agent, such as hydrogen peroxide.

When the cosmetic composition that can be used in the present disclosure is a hair-dyeing composition, such as a composition for dyeing via oxidation of the hair, it generally comprises at least one oxidation base, and optionally at least one coupler.

As oxidation bases that are conventionally used, non-limiting mention may be made of ortho- and para-phenylenediamines, double bases, ortho- and para-aminophenols, the heterocyclic bases below and also the acid addition salts thereof.

Mention may be made of, by way of non-limiting example:
(A) para-phenylenediamines of formula (II) below and the acid addition salts thereof:

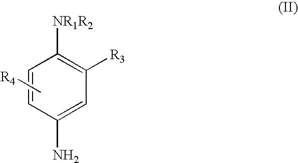

in which:

R₁ represents a hydrogen atom, a C₁-C₄ alkyl radical, a C₁-C₄ monohydroxyalkyl radical, a C₂-C₄ polyhydroxyalkyl radical, a (C₁-C₄)alkoxy(C₁-C₄)alkyl radical or a C₁-C₄ alkyl radical substituted with a nitrogenous, phenyl or 4′-aminophenyl group;

R₂ represents a hydrogen atom, a C₁-C₄ alkyl radical, a C₁-C₄ monohydroxyalkyl radical or a C₂-C₄ polyhydroxyalkyl radical, a (C₁-C₄)alkoxy(C₁-C₄)alkyl radical or a C₁-C₄ alkyl radical substituted with a nitrogenous group;

R₁ and R₂ may also form, with the nitrogen atom which bears them, a 5- or 6-membered nitrogenous heterocycle optionally substituted with at least one alkyl, hydroxyl or ureido group;

R₃ represents a hydrogen atom, a halogen atom such as a chlorine atom, a C₁-C₄ alkyl radical, a sulpho radical, a carboxy radical, a C₁-C₄ monohydroxyalkyl radical, a C₁-C₄ hydroxyalkoxy radical, an acetylamino(C₁-C₄)alkoxy radical, a mesylamino(C₁-C₄)-alkoxy radical or a carbamoylamino(C₁-C₄)alkoxy radical,

R₄ represents a hydrogen or halogen atom or a C₁-C₄ alkyl radical.

Among the nitrogenous groups of formula (II) above, exemplary mention may be made of amino, mono(C₁-C₄)alkylamino, di(C₁-C₄)alkylamino, tri(C₁-C₄)alkylamino, monohydroxy(C₁-C₄)alkylamino, imidazolinium and ammonium radicals.

Among the para-phenylenediamines of formula (II) above, further exemplary mention may be made of para-phenylenediamine, para-tolylenediamine, 2-chloro-para-phenylenediamine, 2,3-dimethyl-para-phenylenediamine, 2,6-dimethyl-para-phenylenediamine, 2,6-diethyl-para-phenylenediamine, 2,5-dimethyl-para-phenylenediamine, N,N-dimethyl-para-phenylenediamine, N,N-diethyl-para-phenylene-diamine, N,N-dipropyl-para-phenylenediamine, 4-amino-N,N-diethyl-3-methylaniline, N,N-bis(β-hydroxyethyl)-para-phenylenediamine, 4-N,N-bis(β-hydroxyethyl)amino-2-methylaniline, 4-N,N-bis(p-hydroxyethyl)amino-2-chloroaniline, 2-p-hydroxyethyl-para-phenylenediamine, 2-fluoro-para-phenylenediamine, 2-isopropyl-para-phenylenediamine, N-(β-hydroxypropyl)-para-phenylenediamine, 2-hydroxymethyl-para-phenylenediamine, N,N-dimethyl-3-methyl-para-phenylenediamine, N,N-(ethyl-β-hydroxyethyl)-para-phenylenediamine, N-(β,γ-dihydroxypropyl)-para-phenylenediamine, N-(4′-aminophenyl)-para-phenylenediamine, N-phenyl-para-phenylenediamine, 2-β-hydroxyethyloxy-para-phenylenediamine, 2-β-acetylaminoethyloxy-para-phenylenediamine, N-(β-methoxyethyl)-para-phenylenediamine and 2-methyl-1-N-β-hydroxyethyl-para-phenylenediamine, and the acid addition salts thereof.

Among the para-phenylenediamines of formula (II) above, even further exemplary mention may be made of para-phenylenediamine, para-tolylenediamine, 2-isopropyl-para-phenylenediamine, 2-β-hydroxyethyl-para-phenylenediamine, 2-β-hydroxyethyloxy-para-phenylenediamine, 2,6-dimethyl-para-phenylenediamine, 2,6-diethyl-para-phenylenediamine, 2,3-dimethyl-para-phenylenediamine, N,N-bis(p-hydroxyethyl)-para-phenylenediamine and 2-chloro-para-phenylenediamine, and the acid addition salts thereof.
(B) According to the disclosure, the term double bases means compounds containing at least two aromatic nuclei bearing amino and/or hydroxyl groups.

Among the double bases which can be used as oxidation bases in the ready-to-use dye compositions in accordance with the disclosure, exemplary mention may be made of the compounds corresponding to formula (III) below, and the acid addition salts thereof:

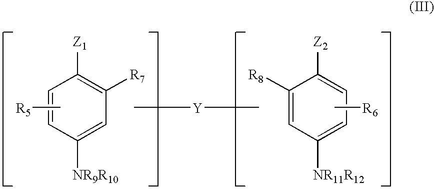

in which:
Z₁ and Z₂, which may be identical or different, represent a hydroxyl or —NH₂ radical which may be substituted with a C₁-C₄ alkyl radical or with a linker arm Y;
the linker arm Y represents a linear or branched alkylene chain containing from 1 to 14 carbon atoms, which may be interrupted by or terminated with at least one nitrogenous group and/or at least one heteroatom such as oxygen, sulphur or nitrogen atom, and optionally substituted with at least one hydroxyl or C₁-C₆ alkoxy radical;
R₅ and R₆ represent a hydrogen or halogen atom, a C₁-C₄ alkyl radical, a C₁-C₄ monohydroxyalkyl radical, a C₂-C₄ polyhydroxyalkyl radical, a C₁-C₄ aminoalkyl radical or a linker arm Y;

R₇, R₈, R₉, R₁₀, R₁₁ and R₁₂, which may be identical or different, represent a hydrogen atom, a linker arm Y or a C₁-C₄ alkyl radical;

it being understood that the compounds of formula (III) contain only one linker arm Y per molecule.

Among the nitrogenous groups of formula (III) above, exemplary mention may be made of amino, mono(C₁-C₄)alkylamino, di(C₁-C₄)alkylamino, tri(C₁-C₄)alkylamino, monohydroxy(C₁-C₄)alkylamino, imidazolinium and ammonium radicals.

Among the double bases of formula (III) above, further exemplary mention may be made of N,N′-bis(β-hydroxyethyl)-N,N′-bis(4′-aminophenyl)-1,3-diaminopropanol, N,N′-bis(β-hydroxyethyl)-N,N′-bis(4′-aminophenyl)ethylenediamine, N,N′-bis(4-aminophenyl)tetramethylenediamine, N,N′-bis(β-hydroxyethyl)-N,N′-bis(4-aminophenyl)-tetramethylenediamine, N,N′-bis(4-methylaminophenyl)tetramethylenediamine, N,N′-bis-(ethyl)-N,N′-bis(4′-amino-3′-methylphenyl)ethylenediamine and 1,8-bis(2,5-diaminophenoxy)-3,5-dioxaoctane, and the acid addition salts thereof.

Among these double bases of formula (III), even further exemplary mention may be made of N,N′-bis(β-hydroxyethyl)-N,N′-bis(4′-aminophenyl)-1,3-diaminopropanol and 1,8-bis(2,5-diaminophenoxy)-3,5-dioxaoctane, and one of the acid addition salts thereof.
(C) The para-aminophenols corresponding to formula (IV) below, and the acid addition salts thereof:

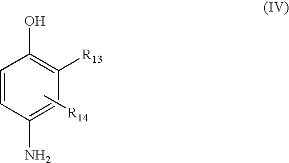

in which:
R₁₃ represents a hydrogen atom, a halogen atom, such as fluorine, or a C₁-C₄ alkyl, C₁-C₄ monohydroxyalkyl, (C₁-C₄)alkoxy(C₁-C₄)alkyl, C₁-C₄ aminoalkyl or hydroxy(C₁-C₄)alkylamino(C₁-C₄)alkyl radical,
R₁₄ represents a hydrogen atom, a halogen atom, such as fluorine, or a C₁-C₄ alkyl, C₁-C₄ monohydroxyalkyl, C₂-C₄ polyhydroxyalkyl, C₁-C₄ aminoalkyl, C₁-C₄ cyanoalkyl or (C₁-C₄)alkoxy(C₁-C₄)alkyl radical.

Among the para-aminophenols of formula (IV) above, exemplary mention may be made of para-aminophenol, 4-amino-3-methylphenol, 4-amino-3-fluorophenol, 4-amino-3-hydroxymethylphenol, 4-amino-2-methylphenol, 4-amino-2-hydroxymethylphenol, 4-amino-2-methoxymethylphenol, 4-amino-2-aminomethylphenol and 4-amino-2-(β-hydroxyethylaminomethyl)phenol, and the acid addition salts thereof.
(D) The ortho-aminophenols which can be used as oxidation bases in the context of the present disclosure are chosen, for example, from 2-aminophenol, 2-amino-1-hydroxy-5-methylbenzene, 2-amino-1-hydroxy-6-methylbenzene and 5-acetamido-2-aminophenol, and the acid addition salts thereof.
(E) Among the heterocyclic bases which can be used as oxidation bases in the dye compositions in accordance with the disclosure, exemplary mention may be made of pyridine derivatives, pyrimidine derivatives and pyrazole derivatives, and the acid addition salts thereof.

Among the pyridine derivatives, exemplary mention may be made of the compounds described, for example, in patents GB 1 026 978 and GB 1 153 196, such as 2,5-diaminopyridine, 2-(4-methoxyphenyl)amino-3-aminopyridine, 2,3-diamino-6-methoxypyridine, 2-(β-methoxyethyl)amino-3-amino-6-methoxypyridine and 3,4-diaminopyridine, and the acid addition salts thereof.

Among the pyrimidine derivatives, exemplary mention may be made of the compounds described, for example, in German patent DE 2 359 399 or Japanese patents JP 88-169 571 and JP 91-10659 or patent application WO 96/15765, such as 2,4,5,6-tetra-aminopyrimidine, 4-hydroxy-2,5,6-triaminopyrimidine, 2-hydroxy-4,5,6-triaminopyrimidine, 2,4-dihydroxy-5,6-diaminopyrimidine and 2,5,6-triaminopyrimidine, and pyrazolopyrimidine derivatives such as those mentioned in patent application FR-A-2 750 048 and among which mention may be made of pyrazolo[1,5-a]pyrimidine-3,7-diamine; 2,5-dimethyl-pyrazolo[1,5-a]pyrimidine-3,7-diamine; pyrazolo[1,5-a]pyrimidine-3,5-diamine; 2,7-dimethyl-pyrazolo[1,5-a]pyrimidine-3,5-diamine; 3-aminopyrazolo[1,5-a]pyrimidin-7-ol; 3-aminopyrazolo[1,5-a]pyrimidin-5-ol; 2-(3-aminopyrazolo[1,5-a]pyrimidin-7-ylamino)ethanol; 2-(7-aminopyrazolo[1,5-a]pyrimidin-3-ylamino)ethanol; 2-[(3-aminopyrazolo[1,5-a]pyrimidin-7-yl)(2-hydroxyethyl)amino]ethanol; 2-[(7-aminopyrazolo[1,5-a]pyrimidin-3-yl)(2-hydroxy-ethyl)amino]ethanol; 5,6-dimethylpyrazolo[1,5-a]pyrimidine-3,7-diamine; 2,6-dimethylpyrazolo[1,5-a]pyrimidine-3,7-diamine; 2,5,N7,N7-tetramethylpyrazolo[1,5-a]-pyrimidine-3,7-diamine and 3-amino-5-methyl-7-imidazolylpropylaminopyrazolo[1,5-a]pyrimidine, and the addition salts thereof and the tautomeric forms thereof, when a tautomeric equilibrium exists, and the acid addition salts thereof.

Among the pyrazole derivatives, exemplary mention may be made of the compounds described in patents DE 3 843 892, DE 4 133 957 and patent applications WO 94/08969, WO 94/08970, FR-A-2 733 749 and DE 195 43 988, such as 4,5-diamino-1-methylpyrazole, 3,4-diaminopyrazole, 4,5-diamino-1-(4′-chlorobenzyl)pyrazole, 4,5-diamino-1,3-dimethylpyrazole, 4,5-diamino-3-methyl-1-phenylpyrazole, 4,5-diamino-1-methyl-3-phenyl pyrazole, 4-amino-1,3-dimethyl-5-hydrazinopyrazole, 1-benzyl-4,5-diamino-3-methylpyrazole, 4,5-diamino-3-tert-butyl-1-methylpyrazole, 4,5-diamino-1-tert-butyl-3-methylpyrazole, 4,5-diamino-1-(β-hydroxyethyl)-3-methylpyrazole, 4,5-diamino-1-(β-hydroxyethyl)pyrazole, 4,5-diamino-1-ethyl-3-methylpyrazole, 4,5-diamino-1-ethyl-3-(4′-methoxyphenyl)pyrazole, 4,5-diamino-1-ethyl-3-hydroxymethylpyrazole, 4,5-diamino-3-hydroxymethyl-1-methylpyrazole, 4,5-diamino-3-hydroxymethyl-1-isopropylpyrazole, 4,5-diamino-3-methyl-1-isopropylpyrazole, 4-amino-5-(2′-aminoethyl)amino-1,3-dimethyl-pyrazole, 3,4,5-triaminopyrazole, 1-methyl-3,4,5-triaminopyrazole, 3,5-diamino-1-methyl-4-methylaminopyrazole and 3,5-diamino-4-(β-hydroxyethyl)amino-1-methylpyrazole, and the acid addition salts thereof.

As pyrazole derivatives, non-limiting mention may also be made of diamino-N,N-dihydropyrazopyrazolones and for example, those described in Application FR 2 886 136 such as the following compounds and the addition salts thereof.

Among these compounds, the exemplary compounds are:
2,3-diamino-6,7-dihydro-1H,5H-pyrazolo[1,2-a]pyrazol-1-one;
2-amino-3-ethylamino-6,7-dihydro-1H,5H-pyrazolo[1,2-a]pyrazol-1-one;
2-amino-3-isopropylamino-6,7-dihydro-1H,5H-pyrazolo[1,2-a]pyrazol-1-one;
2-amino-3-(pyrrolidin-1-yl)-6,7-dihydro-1H,5H-pyrazolo[1,2-a]pyrazol-1-one;
4,5-diamino-1,2-dimethyl-1,2-dihydropyrazol-3-one;
4,5-diamino-1,2-diethyl-1,2-dihydropyrazol-3-one;
4,5-diamino-1,2-di(2-hydroxyethyl)-1,2-dihydro-pyrazol-3-one;
2-amino-3-(2-hydroxyethyl)amino-6,7-dihydro-1H,5H-pyrazolo[1,2-a]pyrazol-1-one;
2-amino-3-dimethylamino-6,7-dihydro-1H,5H-pyrazolo[1,2-a]pyrazol-1-one;
2,3-diamino-5,6,7,8-tetrahydro-1H,6H-pyridazino[1,2-a]pyrazol-1-one;
4-amino-1,2-diethyl-5-(pyrrolidin-1-yl)-1,2-dihydro-pyrazol-3-one;
4-amino-5-(3-dimethylamino-pyrrolidin-1-yl)-1,2-diethyl-1,2-dihydro-pyrazol-3-one;
2,3-diamino-6-hydroxy-6,7-dihydro-1H,5H-pyrazolo[1,2-a]pyrazol-1-one.

As heterocyclic bases, use will, for example, be made of 4,5-diamino-1-(β-hydroxyethyl)pyrazole, 2,3-diamino-6,7-dihydro-1H,5H-pyrazolo[1,2-a]pyrazol-1-one and addition salts thereof.

The coupler(s) which may be used are those conventionally used in oxidation dye compositions, that is to say meta-aminophenols, meta-phenylenediamines, meta-diphenols, naphthols and heterocyclic couplers such as, for example, indole derivatives, indoline derivatives, sesamol and its derivatives, pyridine derivatives, pyrazolotriazole derivatives, pyrazolones, indazoles, benzimidazoles, benzothiazoles, benzoxazoles, 1,3-benzodioxoles and quinolines, and the acid addition salts thereof.

These couplers are chosen, for example, from 2,4-diamino-1-(β-hydroxyethyloxy)benzene, 2-methyl-5-aminophenol, 5-N-(β-hydroxyethyl)amino-2-methyl phenol, 3-aminophenol, 1,3-dihydroxybenzene, 1,3-dihydroxy-2-methylbenzene, 4-chloro-1,3-dihydroxybenzene, 2-amino-4-(β-hydroxyethylamino)-1-methoxybenzene, 1,3-diaminobenzene, 1,3-bis(2,4-diaminophenoxypropane, sesamol, 1-amino-2-methoxy-4,5-methylenedioxybenzene, α-naphthol, 6-hydroxyindole, 4-hydroxyindole, 4-hydroxy-N-methylindole, 6-hydroxyindoline, 2,6-dihydroxy-4-methylpyridine, 1H-3-methylpyrazol-5-one, 1-phenyl-3-methylpyrazol-5-one, 2-amino-3-hydroxypyridine, 3,6-dimethyl-pyrazolo[3,2-c]-1,2,4-triazole and 2,6-dimethylpyrazolo[1,5-b]-1,2,4-triazole, and the acid addition salts thereof.

The oxidation base(s) and the coupler(s) are in general present in an amount ranging from 0.0005% to 12% by weight, such as in an amount ranging from 0.01% to 8% by weight, relative to the total weight of the composition.

In general, the acid addition salts of the oxidation bases and couplers are chosen, for example, from the hydrochlorides, hydrobromides, sulphates, tartrates, lactates and acetates.

The dye composition may also be a lightening direct dye composition. This composition may then contain at least one direct dye that may, for example, be chosen from neutral, acidic or cationic nitrobenzene dyes, neutral, acidic or cationic azo direct dyes, neutral, acidic or cationic quinone and for example, anthraquinone direct dyes, azine direct dyes, triarylmethane direct dyes, indoamine direct dyes and natural direct dyes.

The direct dye(s) may for example, be present in an amount ranging from 0.001 to 20% by weight and such as from 0.005 to 10% by weight of the total weight of the ready-to-use composition.

According to at least one embodiment, the dye composition comprises, as a mixture, at least one oxidation base and at least one direct dye.

The suitable medium (or support) for the composition used in the disclosure is for example, an aqueous medium composed of water and may also contain at least one organic solvent acceptable from a cosmetic point of view, including for example, alcohols such as ethyl alcohol, isopropyl alcohol, benzyl alcohol and phenylethyl alcohol, or glycols or glycol ethers such as, for example, monomethyl ether, ethylene glycol monoethyl and monobutyl ethers, propylene glycol or its ethers such as, for example, propylene glycol monomethyl ether, butylene glycol, dipropylene glycol and also diethylene glycol alkyl ethers such as, for example, diethylene glycol monoethyl ether or monobutyl ether. The at least one solvent may then be present in an amount ranging from around 0.5 to 20% by weight and such as from around 2 to 10% by weight relative to the total weight of the composition.

The cosmetic composition that can be used in the disclosure may also contain various adjuvants conventionally used in cosmetic compositions, such as anionic, cationic, non-ionic, amphoteric or zwitterionic surfactants or mixtures thereof, polymers other than the polycondensates of the present disclosure, mineral or organic thickening agents, other antioxidants or free-radical scavengers, penetrating agents, sequestering agents, fragrances, buffers, dispersants, conditioning agents such as, for example, volatile or non-volatile, modified or unmodified silicones, film-forming agents, ceramides, preservatives and opacifiers.

The above adjuvants are in general present in an amount, for each of them, from 0.01 to 20% by weight relative to the weight of the composition.

Of course, a person skilled in the art will be sure to choose the optional additional compound or compounds mentioned above so that the beneficial properties intrinsically linked to the method according to the disclosure are not, or not substantially, impaired by the envisaged addition(s).

The composition that can be used according to the present disclosure may be applied to keratin fibers such as the hair.

According to one method that uses the compositions described previously, these compositions are applied to the fibers, and optionally rinsed. When it is a dye composition, this composition is applied to the fibers for a sufficient time to develop the desired coloring, then the fibers are rinsed, washed optionally with shampoo, rinsed again and dried.

The examples that follow are intended to illustrate the invention without however limiting the scope thereof.

### EXAMPLE

Method for Evaluating the Antioxidant/Free-Radical Scavenging Activity of the Polymers of the Invention with Respect to a UVA Oxidative Stress Induced on Keratinocytes

The technique for evaluating the photoprotection was carried out according to a well-known method (J. of Photochemistry and Photobiology B: Biology 57 (2000) 102-112 TOBI et al: Glutathione modulates the level of free radicals produced in UVA irradiated cells). This technique used a fluorescent probe, a marker for intracellular global oxidative stress, 2′-7′-dichlorofluorescin diacetate (DCFH-DA).

### Principle

The use of DCFH-DA as a marker of the oxidative stress rests on its physicochemical properties. It is an apolar and non-ionic molecule capable of diffusing through cell membranes. Once inside the cell, DCFH-DA will be hydrolysed by intracellular esterases to a non-fluorescent compound: DCFH or 2,7-dichlorofluorescin. In the presence of activated oxygen species, DCFH is rapidly oxidized to a highly fluorescent compound: DCF or 2,7-dichlorofluorescein.

### Procedure

Three compounds were tested: hexadimethrine chloride (MEXOMERE PO from Chimex corresponding to a polycondensate of formula (I)), citric acid and glycine (0.0001% w/v for the MEXOMERE PO, 30 μM for the citric acid and the glycine).

1. Treatment of the Keratinocytes

At confluence, the keratinocytes were incubated in the presence of the compounds to be tested for 24 hours at 37° C., 5% CO₂, in the culture medium, according to a dose effect (3 concentrations).

2. Incorporation of DCFH-DA

The pretreated keratinocytes were rinsed then incubated in the presence of DCFH-DA in the dark.

3. Exposure to UVA

After this incubation, the DCFH-DA solution was removed, the cells were then exposed to UVA (2 J/cm²).

Observation: an unexposed control plate was kept in darkness at room temperature.

4. Measurement of the Fluorescence

The fluorescence of DCF was evaluated immediately after the exposure to UVA, by spectrofluorimetry (excitation: 480 nm; emission: 530 nm).

5. Results:
MEXOMERE PO has an antioxidant efficacy, with respect to the UVA oxidative stress induced on HaCaT, with a protection of around 23% at 0.0001% (i.e. 0.08 μM).

Citric acid and glycine have an antioxidant efficacy with a level of protection close to 18% and 15% at 30 μM.

The efficacy of MEXOMERE PO is greater than that of glycine or citric acid.

### Composition Example

The following one dye composition was prepared;

(expressed in grams unless indicated otherwise)

Dye composition.

| | CONCEN- |
|---|---|
| | TRATION |
| | (g) |
| AMMONIUM THIOLACTATE AS A 58% | 0.80 |
| AQUEOUS SOLUTION (50% AS | |
| THIOLACTIC ACID) | |
| AQUEOUS AMMONIA (REFERENCE | 10 |
| CONCENTRATION 20% OF AMMONIA) | |
| PURE MONOETHANOLAMINE | 1.35 |
| PYROGENIC SILICA WITH A HYDROPHOBIC | 1.20 |
| NATURE | |
| 1-BETA-HYDROXYETHYLOXY-2,4-DIAMINO- | 0.15 |
| BENZENE DICHLORHYDRATE | |
| 2-METHYL-1,3-DIHYDROXYBENZENE | 0.81 |
| (2-METHYLRESORCINOL) | |
| TITANIUM OXIDE (UNTREATED ANATASE) | 0.15 |
| COATED WITH POLYDIMETHYLSILOXANE | 0.15 |
| (98/2) (Cl: 77891) | |
| N,N-BIS(2-HYDROXYETHYL)-P-PHENYLENE- | 0.21 |
| DIAMINE SULPHATE, 1 H₂O | |
| 1,3-DIHYDROXYBENZENE (RESORCINOL) | 1.29 |
| 1-HYDROXY-3-AMINO-BENZENE | 0.33 |
| 1,4-DIAMINO-BENZENE | 1.84 |
| GLYCOL DISTEARATE | 2 |
| CETYLSTEARYL ALCOHOL (C16/C18: 50/50) | 11.50 |
| FRAGRANCE | 0.60 |
| TETRAMETHYLHEXAMETHYLENEDIAMINE/1,3- | 4 |
| DICHLOROPROPYLENE POLYCONDENSATE IN | |
| AQUEOUS SOLUTION | |
| CARBOXYVINYL POLYMER SYNTHESIZED IN | 0.60 |
| THE ETHYL ACETATE/CYCLOHEXANE MIXTURE | |
| PROPYLENE GLYCOL | 7 |
| NATURAL LAURIC ACID | 3 |
| OXYETHYLENATED LAURYL ALCOHOL | 7 |
| (12 EO) | |
| OXYETHYLENATED DECYL ALCOHOL (3 EO) | 10 |
| OXYETHYLENATED OLEOCETYL ALCOHOL | 4 |
| (30 EO) | |
| DEIONIZED WATER | QS FOR 100 g |

This composition was mixed weight for weight with an oxidizing agent at pH 2.3 comprising 9% hydrogen peroxide. The resulting mixture was applied to grey hair containing 90% white hair for 30 min. After rinsing and drying the hair was dyed a chestnut shade. The hair was soft and was not very degraded.

What is claimed is:

1. A method for providing a free-radical scavenging and/or antioxidant effect comprising
including in a cosmetic treatment composition at least one free-radical scavenger or at least one antioxidant chosen from at least one quaternary diammonium polycondensates comprising repeat units corresponding to the formula (I) below 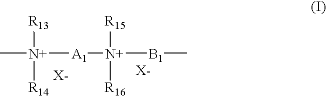
in which formula (I):
R₁₃, R₁₄, R₁₅ and R₁₆, which are identical or different, represent cyclic or non-cyclic aliphatic, or arylaliphatic groups comprising 1 to 6 carbon atoms or hydroxyalkylaliphatic groups comprising 1 to 4 carbon atoms, or else R₁₃, R₁₄, R₁₅ and R₁₆, together or separately, constitute, with the nitrogen atoms to which they are attached, heterocycles optionally comprising a second heteroatom other than nitrogen or else R₁₃, R₁₄, R₁₅ and R₁₆ represent a linear or branched C₁-C₆ alkyl group substituted with a nitrile, ester, acyl, amide or —CO—O—R₁₇-D or —CO—NH—R₁₇-D group where R₁₇ is an alkylene group and D a quaternary ammonium group;
A₁ and B₁ represent polymethylene groups comprising 2 to 6 carbon atoms that may be linear or branched, saturated or unsaturated, and that may contain, linked to or inserted in the main chain, at least one aromatic rings, or at least one entity chosen from oxygen and sulphur atoms and sulphoxide, sulphone, disulphide, amino, alkylamino, hydroxyl, quaternary ammonium, ureido and ester groups; and
X⁻ is a mineral or organic acid anion.

2. The method according to claim 1, wherein, in the at least one quaternary diammonium polycondensate, A₁, R₁₃ and R₁₅ forms, with the two nitrogen atoms to which they are attached, a piperazine ring.

3. A method for providing a free-radical scavenging and/or antioxidant effect comprising
including in a cosmetic treatment composition at least one free-radical scavenger or at least one antioxidant chosen from at least one quaternary diammonium polycondensates composed of repeat units corresponding to the formula (a) below: 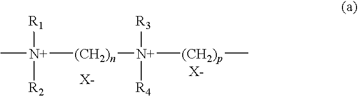
in which R₁, R₂, R₃ and R₄, which are identical or different, denote an alkyl or hydroxyalkyl group having from 1 to 4 carbon atoms, n and p are integers that vary from 2 to 6 and X⁻ is a mineral or organic acid anion.

4. The method according to claim 3, wherein the at least one quaternary diammonium polycondensate is hexadimethrine chloride for which R₁, R₂, R₃ and R₄ represent a methyl group and n=3, p=6 and X⁻=Cl⁻.

5. The method according to claim 1, wherein the at least one quaternary diammonium polycondensate is present in an amount ranging from 0.00001% to 10% by weight relative to the total weight of the composition.

6. The method according to claim 1, wherein the cosmetic treatment composition is aqueous.

7. The method according to claim 1, wherein the cosmetic treatment composition further comprises at least one oxidizing agent.

8. The method according to claim 7, wherein the at least one oxidizing agent is chosen from hydrogen peroxide, urea peroxide, alkali metal bromates, persalts, peracids and oxidase enzymes.

9. The method according to claim 1 wherein the cosmetic treatment composition further comprises at least one oxidation base chosen from bisphenylalkylenediamines, para-phenylenediamines, ortho-aminophenols, para-aminophenols, heterocyclic bases, and the acid addition salts thereof, and optionally at least one coupler chosen from meta-phenylenediamines, meta-aminophenols, meta-diphenols, naphthalenic couplers, heterocyclic couplers and the addition salts thereof.

10. The method according to claim 1, wherein the cosmetic treatment composition further comprises at least one direct dye.

11. The method according to claim 1, wherein the cosmetic treatment composition has a pH ranging from 7 to 14.

12. The method according to claim 11, wherein the cosmetic treatment composition has a pH ranging from 8 to 12.
